(19) United States
(12) Patent Application Publication
(10) Pub. No.: US 2014/0216908 A1
(43) Pub. Date: Aug. 7, 2014

(54) KEYBOARD ASSEMBLY

(71) Applicant: HON HAI PRECISION INDUSTRY CO., LTD., New Taipei (TW)

(72) Inventors: CHIA-MING CHANG, New Taipei (TW); YI-CHENG KUO, New Taipei (TW)

(73) Assignee: HON HAI PRECISION INDUSTRY CO., LTD., New Taipei (TW)

(21) Appl. No.: 14/141,764

(22) Filed: Dec. 27, 2013

(30) Foreign Application Priority Data
Feb. 5, 2013 (TW) 102104491

(51) Int. Cl. H01H 13/02; H01H 13/76

(52) U.S. Cl. CPC H01H 13/023; H01H 13/76
USPC 200/5 R

(57) ABSTRACT

A keyboard assembly includes a keyboard unit, a securing bracket, and an outer panel. The keyboard unit includes a base panel and a number of keys mounted on the base panel. The securing bracket defines a number of receiving holes receiving the keys. The outer panel includes a transmission portion and a light shield layer attached on the transmission portion. The transmission portion defines a number of light holes also receiving the keys. The light shield layer is used for reflecting light from the transmission to emit into the light holes, thereby lighting the keys.

### BACKGROUND

1. Technical Field

The present disclosure generally relates to a keyboard assembly.

2. Description of Related Art

A notebook computer usually includes a keyboard and a backlight unit. The backlight unit lights the keyboard. With the trend towards miniaturization, there is a need for decreasing the thickness of the keyboard and the backlight unit.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a keyboard assembly.

FIG. 2 is similar to FIG. 1, but viewed from another aspect.

FIG. 3 is an enlarged view of the portion III of FIG. 1.

FIG. 4 is an assembled view of the keyboard assembly of FIG. 1.

FIG. 5 is an enlarged view of the portion V of FIG. 4.

FIG. 6 is an assembled view of the keyboard assembly of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

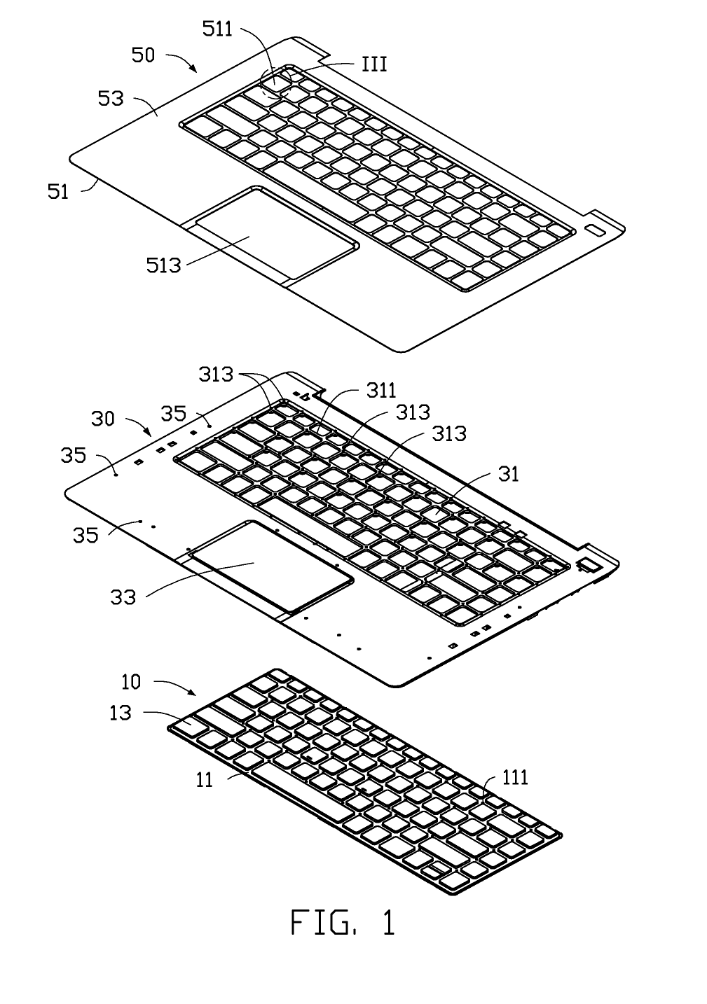

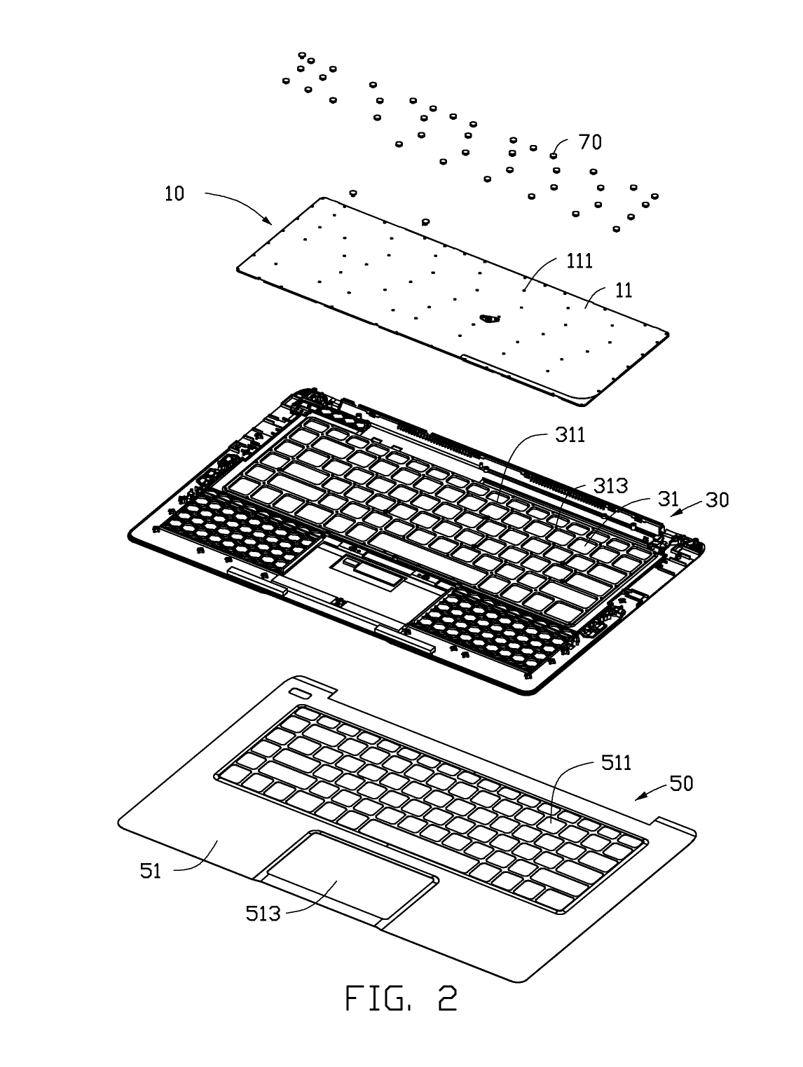

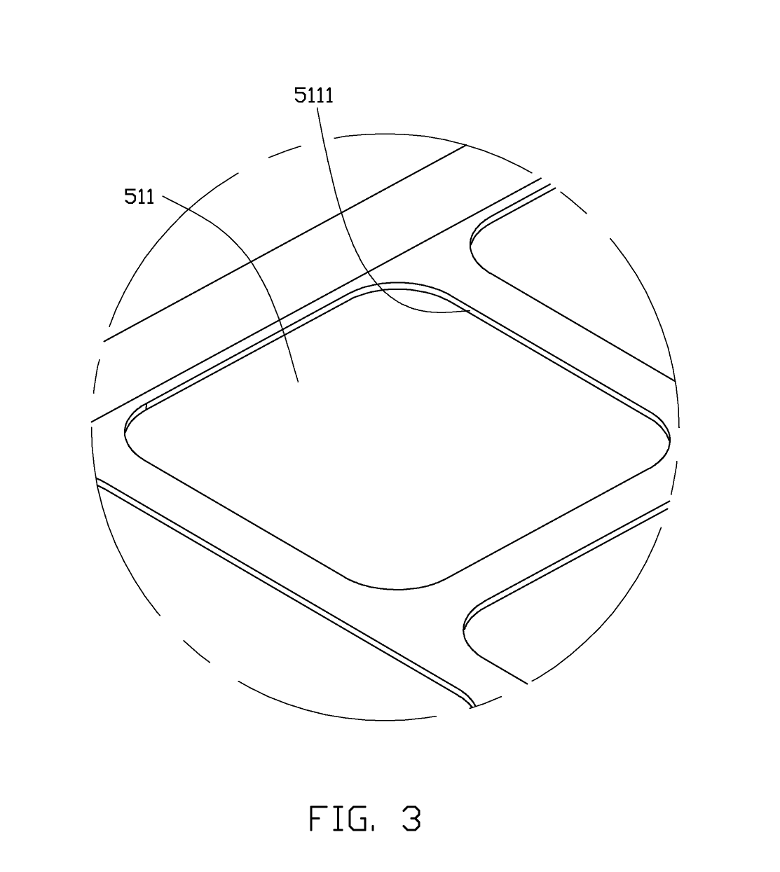

FIGS. 1, 2, and 3 show a keyboard assembly of one embodiment. The keyboard assembly includes a keyboard unit 10, a securing bracket 30, and an outer panel 50.

The keyboard unit 10 includes a base panel 11 and a plurality of keys 13 mounted on the base panel 11. The base panel 11 defines a plurality of through holes 111.

The securing bracket 30 defines a plurality of receiving holes 31 corresponding to the keys 13. A touch panel 33 is mounted on the securing bracket 30. The securing bracket 30 includes a separating rim 311 located between two adjacent receiving holes 31. The securing bracket 30 defines a plurality of securing holes 313 located in the rims 311. The securing holes 313 correspond to the through holes 111 of the base panel 11. The securing bracket 30 further defines a plurality of mounting holes 35 for receiving light members (not shown). In one embodiment, the light members are LEDs.

The shape of the outer panel 50 matches the shape of the securing bracket 30. The outer panel 50 includes a transmission portion 51 and a light shield layer 53 attached to the transmission portion 51. In one embodiment, the transmission portion 51 is made of glass.

The transmission portion 51 defines a plurality of light holes 511 and an opening 513 corresponding to the touch panel 33. The light hole 511 includes an inner surface 5111. The light members are configured to pass through the mounting holes 35 to light the transmission portion 51 of the outer panel 50.

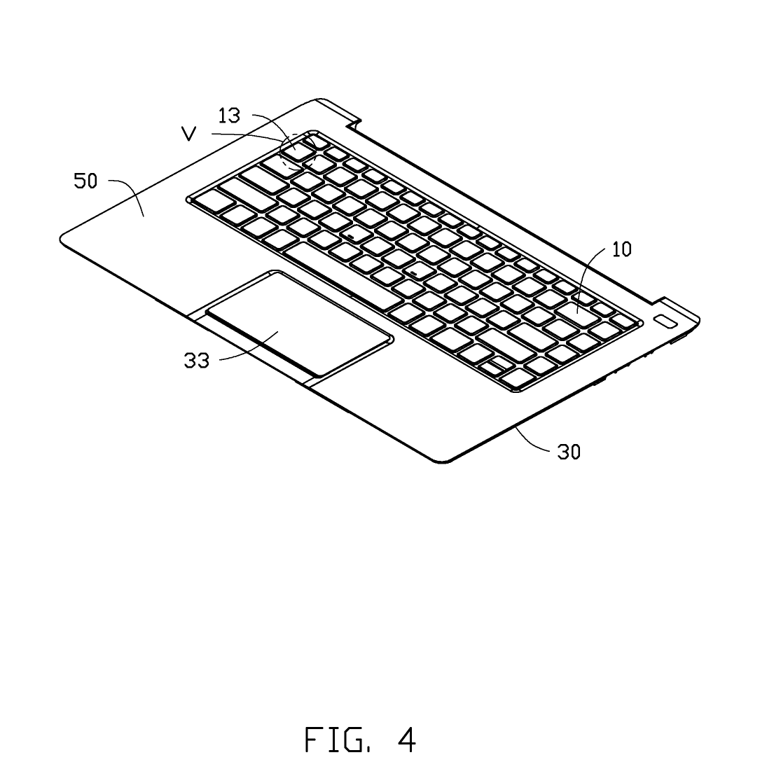

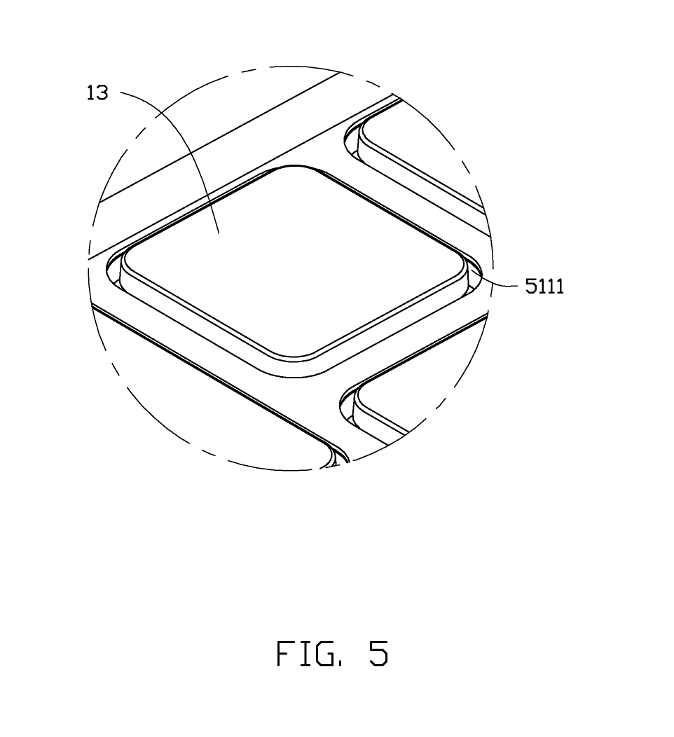

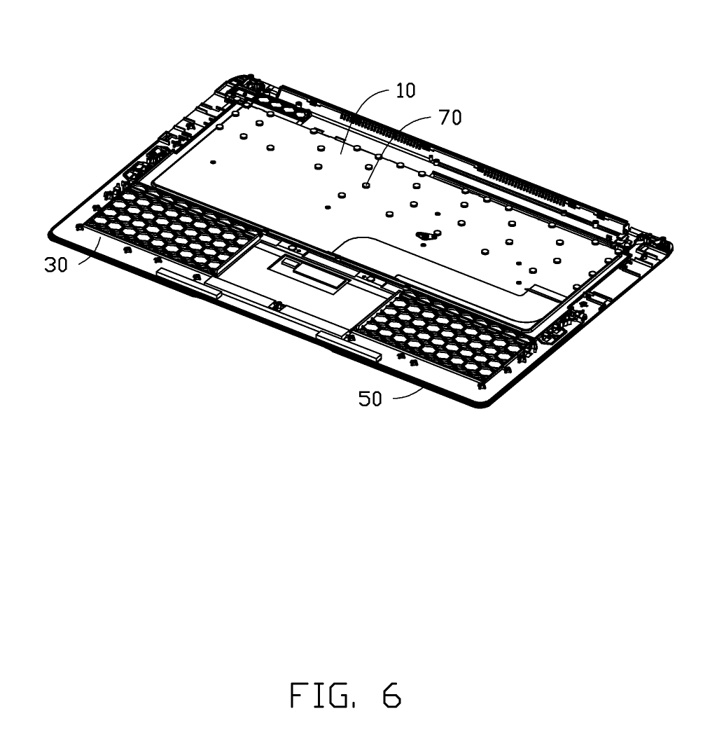

FIGS. 4, 5, and 6 show that in assembly, the keys 13 of the keyboard unit 10 are aligned with the receiving holes 31 of the securing bracket 30. The securing bracket 30 moves to the keyboard unit 10 to enable the keys 13 to pass through the receiving holes 31. At this time, the through holes 111 of the keyboard unit 10 are aligned with the securing holes 313. A plurality of fasteners 70 extend through the through holes 111 and are screwed into the securing holes 313, thereby securing the keyboard unit 10 to the securing bracket 30. The outer panel 50 is mounted to the securing bracket 30 via glue to enable the light hole 511 to be aligned with the receiving holes 31. At this time, the keys 13 are located in the light holes 511.

The keyboard assembly is mounted to a printed circuit board (not shown). The printed circuit board includes a plurality of light members (not shown). The light members pass through the mounting holes 35. In use, the light from the light members emits into the transmission portion 51 of the outer panel 50. And then the light is reflected by the light shield layer 53 to emit into the light holes 511 via the inner surfaces 5111, thereby lighting the keys 13 in the light holes 511. The thickness of the notebook computer is decreased as the outer panel 50 acts as the backlight unit lighting the keys 13.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A keyboard assembly comprising:
a keyboard unit, the keyboard unit comprises a base panel and a plurality of keys mounted on the base panel;
a securing bracket, the securing bracket defines a plurality of receiving holes receiving the plurality of keys; and
an outer panel, the outer panel comprises a transmission portion and a light shield layer attached on the transmission portion, the transmission portion defines a plurality of light holes receiving the plurality of keys; and the light shield layer is configured to reflect light from the transmission portion to emit into the plurality of light holes, thereby lighting the plurality of keys.

2. The keyboard assembly of claim 1, wherein the securing bracket defines a plurality of through holes, and the base panel defines a plurality of securing holes corresponding to the plurality of through holes.

3. The keyboard assembly of claim 2, wherein the securing bracket comprises a rim located each two adjacent ones of the plurality of receiving holes, and the plurality of through holes are defined in the rims.

4. The keyboard assembly of claim 1, wherein a touch panel is mounted on the securing bracket, and the outer panel defines an opening corresponding to the touch panel.

5. The keyboard assembly of claim 1, wherein the securing bracket defines a plurality of mounting holes, and each of the plurality of mounting holes is configured to receive a light member.

6. The keyboard assembly of claim 1, wherein the transmission portion is made of glass.

7. The keyboard assembly of claim 1, wherein the outer panel is glued to the securing bracket.

8. The keyboard assembly of claim 1, wherein a shape of the outer panel matches a shape of the securing bracket.

9. A keyboard assembly comprising:
a keyboard unit, the keyboard unit comprises a base panel and a plurality of keys mounted on the base panel;
a securing bracket, the securing bracket defines a plurality of receiving holes; the securing bracket contacts the base panel; and the plurality of keys are received in the plurality of receiving holes; and
an outer panel, the outer panel comprises a transmission portion and a light shield layer attached on the transmission portion, and the transmission portion defines a plurality of light holes; the transmission portion contacts the securing bracket and the plurality of light holes are aligned with the plurality of receiving holes; the securing bracket is located between the outer panel and the base panel; and the transmission portion is located between the light shield layer and the securing bracket; the plurality of keys are received in the plurality of light holes; and the light shield layer is configured to reflect light from the transmission portion to emit into the plurality of light holes, thereby lighting the plurality of keys.

10. The keyboard assembly of claim 9, wherein the securing bracket defines a plurality of through holes, and the base panel defines a plurality of securing holes corresponding to the plurality of through holes.

11. The keyboard assembly of claim 10, wherein the securing bracket comprises a rim located each two adjacent ones of the plurality of receiving holes, and the plurality of through holes are defined in the rims.

12. The keyboard assembly of claim 9, wherein a touch panel is mounted on the securing bracket, and the outer panel defines an opening corresponding to the touch panel.

13. The keyboard assembly of claim 9, wherein the securing bracket defines a plurality of mounting holes, and each of the plurality of mounting holes is configured to receive a light member.

14. The keyboard assembly of claim 9, wherein the transmission portion is made of glass.

15. The keyboard assembly of claim 9, wherein the outer panel is glued to the securing bracket.

16. The keyboard assembly of claim 9, wherein a shape of the outer panel matches a shape of the securing bracket.
